(19) United States
(12) Patent Application Publication
(10) Pub. No.: US 2006/0097986 A1
(43) Pub. Date: May 11, 2006

(54) Image display system

(75) Inventor: Toshinori Mizuno, Tajimi-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/270,450

(22) Filed: Nov. 10, 2005

(30) Foreign Application Priority Data
Nov. 10, 2004 (JP) 2004-326525

(51) Int. Cl. G09G 5/00

(52) U.S. Cl. 345/156

(57) ABSTRACT

In an image display system, a manipulation signal obtaining unit obtains a manipulation signal in accordance with manipulation of manipulation switches. A display control unit controls to display a plurality of switch indicators, which are selectable based on the manipulation signal, on a display screen. A storing unit stores correspondences between the manipulation signal and a display content to be displayed next on the display screen, for the respective switch indicators. The display control unit determines the display content to be displayed next based on the manipulation signal obtained by the manipulation signal obtaining unit and the correspondence stored in the storing unit, and displays the determined display content on the display screen.

### CROSS REFERENCE TO RELATED APPLICATION

This application is based on Japanese Patent Application No. 2004-326525 filed on Nov. 10, 2004, the disclosure of which is incorporated herein by reference.

### FIELD OF THE INVENTION

The present invention relates to an image display system that selects switch indicators, which are selectable based on signals sent from manipulation switches such as direction keys, an enter key, and controls processing, and the system is for example used for a navigation system.

### BACKGROUND OF THE INVENTION

In an image display system, it is known to display information groups consisting of a plurality of sub-information and a pointer for pointing the sub information on a display screen. In accordance with operation of a direction key by a user, the pointer is shifted in a designated direction. Also, pointer movable marks indicative of directions to which the pointer can be shifted with respect to the information group are displayed on the display screen. This kind of image display system is for example known in Japanese Unexamined Patent Publication No. 2002-62859A (US 2002/0067352A1).

Further, it is known to display a plurality of screen sections on the same display screen in such an image display system. A navigation device usually has various functions such as a map display function for displaying a cursor indicating a position of a subject vehicle on a map screen, and searching functions for searching based on retrieval conditions such as names of facilities and addresses. As shown in FIG. 10, a map screen (section L) and a list screen (section R) showing a hit list are displayed side by side on the same display screen.

In FIG. 10, switch indicators X1, X2 are displayed on the map of the map screen L, and a plurality of switch indicators Y1 through Y4 are displayed in the list screen R. The switch indicators X1, X2, Y1 through Y4 are selected in accordance with operation of direction keys including a left key, a right key, an up key and a down key, provided on a remote controller. Further, a predetermined function is executed in accordance with operation of an enter key of the remote controller.

In such a navigation system, when the direction key is operated by a user in a condition that both the list screen and the map screen are displayed on the display screen, a switch indicator to be selected next is determined based on relative position of the switch indicators displayed on the display screen. That is, the switch indicator that is located closest in a direction indicated by the direction key is determined as the switch indicator to be selected next. Therefore, the switch indicator on the list screen may be accidentally selected during operation on the map screen. On the contrary, the switch indicator on the map screen may be accidentally selected during operation on the list screen.

Further, as shown in FIG. 11, it is known to display an up switch U and a down switch D for scrolling listed switch indicators. For example, when the up switch is selected by operation of the direction key and the enter key is pressed on the remote controller, switch indicators U1 to U3 are scrolled down. On the contrary, when the down key is selected by operation of the direction key and the enter key is pressed on the remote controller, the switch indicators U1 to U3 are scrolled up. In this way, hidden switch indicators can be shown on the display screen. In such a system, however, the operation of selecting the indicators such as the up switch U and the down switch D and the operation of pressing the enter key are required.

### SUMMARY OF THE INVENTION

The present invention is made in view of the foregoing matter and it is an object of the present invention to provide an image display system with enhanced switch operability.

To achieve the above object, an image display system of the present invention is provided with a manipulation signal obtaining unit for obtaining a manipulation signal in accordance with manipulation of a manipulation switch; a display control unit for displaying switch indicators selectable in accordance with the manipulation signal on a display screen; and a storing unit for storing correspondences between the manipulation signal and a display content to be displayed next on the display screen for the respective switch indicators. Further, the display control unit determines the display content to be displayed next based on the manipulation signal obtained by the manipulation signal obtaining unit and the correspondence stored in the storing unit, and displays the determined display content on the display screen.

Accordingly, the display content to be displayed next is determined by the display control unit based on the obtained manipulation signal and the stored correspondence. Therefore, the switch indicator to be selected next is not determined based on relative positions of the switch indicators on the display screen. For example, it is less likely that a switch indicator in a first screen section of the display screen will be selected based on the relative positions of the switch indicators during operation of the switch indicators on a second screen section of the display screen. Accordingly, operability of the manipulation switches is enhanced.

Further, a list screen is scrolled without displaying scroll switches such as up and down switches on the display screen. Therefore, the operability of the manipulation switches is further enhanced. Also, since it is not necessary to display the scroll switches for scrolling the list screen, flexibility of arranging plural items on the display screen improves.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic block diagram of a navigation system as an image display system according to a first embodiment of the present invention;

FIG. 2 is a plan view of a remote controller according to the first embodiment;

FIG. 3 is an example of a display image of a display unit according to the first embodiment;

FIG. 4 is another example of a display image of the display unit according to the first embodiment;

FIG. 5 is a flow chart showing an image display process executed by a CPU of a control unit according to the first embodiment;

FIGS. 6A and 6B are examples of display images of a display unit according to a second embodiment of the present invention;

FIG. 7 is a flow chart showing a display control process executed by a CPU of a control unit according to the second embodiment;

FIG. 8 is an example of a display image of a display unit according to a third embodiment of the present invention;

FIG. 9 is a flow chart showing a display control process executed by a CPU of a control unit according to the third embodiment;

FIG. 10 is an example of a display image of a display device as a related art; and

FIG. 11 is an example of a display image of a display device as a related art.

### DETAILED DESCRIPTION OF EMBODIMENTS

Embodiments of the present invention will be described hereinafter with reference to the drawings.

### First Embodiment

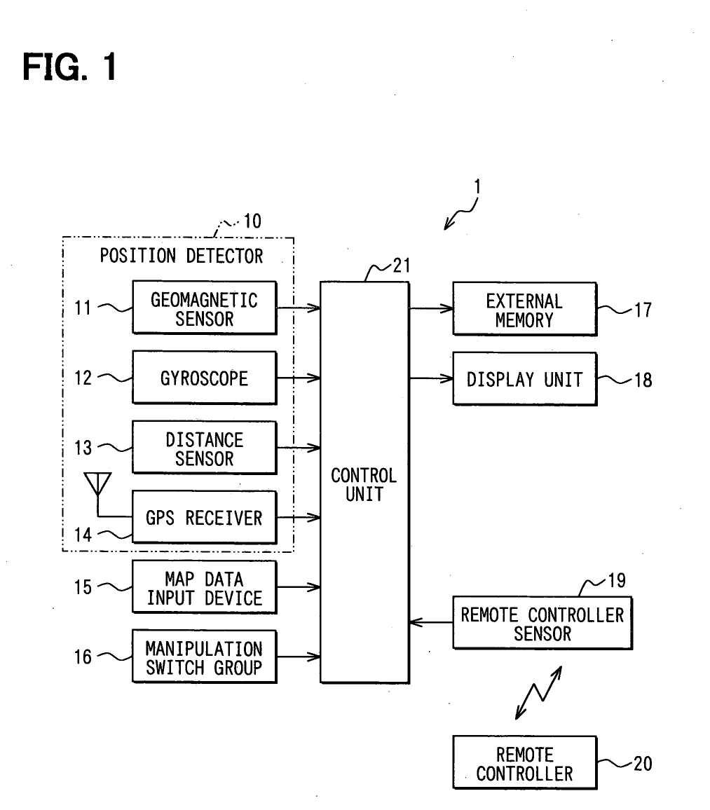

An image display system of the first embodiment is for example applied to a navigation system for a vehicle. As shown in FIG. 1, a navigation system 1 has a position detector 10, a map data input device 15, a group of manipulation switches 16, an external memory 17, a display unit 18, a remote controller sensor 19, and a control Unit 21. The preceding devices are connected to the control unit 21.

The position detector 10 includes a geomagnetic sensor 11, a gyroscope 12, a distance sensor 13 and a GPS (Global Positioning System) receiver 14 for detecting a current position of a vehicle based on radio waves from satellites. Each device 11 to 14 has a different characteristic and detection accuracy, so respective errors are adjusted through combining the devices 11 to 14 to obtain high position detection accuracy.

The map data input device 15 includes a storage medium and inputs various data such as map data, landmark data, and map matching data for improving accuracy of position detection stored in the storage medium. As the storage medium, CD-ROM and DVD-ROM are usually used because of the volume of data. Instead, another medium such as a memory card and a hard disk can be used.

The manipulation switch group 16 is an input device that is for example consists of button switches (mechanical switches) provided around a display screen of the display unit 18, or a touch panel switch overlaid on the display screen of the display unit 18. The manipulation switch group 16 transmits signals to the control unit 21 in accordance with manipulation of the mechanical switches or the touch panel switch.

The external memory 17 is a writable mass-storage device such as a hard disk. The external memory 17 is for example used for storing a volume of data, and data that are not allowed to delete even when the system is turned off. Further, the external memory 17 can be used for copying data, which is frequently used, from the map data input device 15. Here, the external memory 17 can be a removable memory having relatively small storage capacity.

The display unit 18 has a display such as a liquid crystal display. Appropriate pictures or images are displayed on a display screen of the display in accordance with video signals from the control unit 21. The display unit 18 is used for displaying maps, a destination selecting screen, and the like for navigation. For example, the display can be a full-color LC display, a full-color organic EL display, or the like.

The remote controller 20 transmits radio signals, such as infrared radiation, to the remote controller sensor 19 in accordance with user's manipulation of manipulation switches. The remote controller sensor 19 outputs the radio signals to the control unit 21.

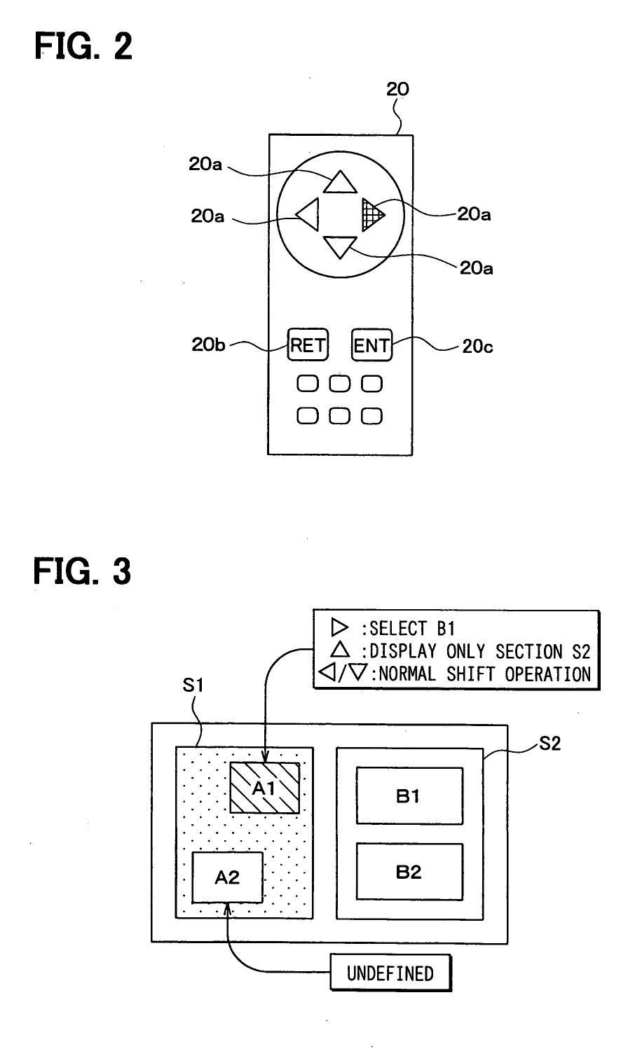

As shown in FIG. 2, the remote controller 20 has direction keys 20a for indicating up, down, left and right, an enter key 20b, and a return key 20c. The remote controller 20 transmits predetermined manipulation signals in accordance with manipulation of the respective keys.

The control unit 21 is constructed as a common computer having CPU, ROM, RAM, I/O, and a bus that is connected with the preceding components, although not illustrated in FIG. 1. The control unit 21 executes various processes based on various information input from the position detector 10, the map data input device 15, the manipulation switch group 16, the external memory 17, the display unit 18 and the remote controller sensor 19.

Specifically, in staring up the navigation system 1, the control unit 21 reads a boot program, an operating system (OS), and the like from the ROM and starts processes. Programs such as a menu program, a destination setting program, a route searching program, a map displaying program are operated on the operating system.

In the menu program, various programs, which are operated on the operating system, are displayed in the menu hierarchically according to the functions and the purposes of the program. When a program is selected from the menu, the process of the selected program is started.

The destination setting program is for setting a destination. In the destination setting program, the display unit 18 is controlled to display an indication for requesting the user to input a destination. When the destination is input by using the manipulation switch group 16 or the remote controller 20, the designated destination is stored in the RAM of the control unit 21. In this way, the user's destination is set.

In addition, the destination setting program of the first embodiment has various retrieval functions based on the name of facilities and addresses (genre retrieval function, address retrieval function), as one of methods of setting the destination. Retrieval results are displayed in a form of list on the display screen of the display unit 18 by the retrieval functions. When the user selects one of the retrieval results, the destination is set.

The route searching program automatically selects an optimum route from the current position to the destination and forms a guide route, when the destination is set by the manipulation switch group 16 or the remote controller 20. Then, the guide route is displayed on the display screen of the display unit 18. For example, Dijikstra's algorithm is known as an algorithm of automatically setting an optimum route.

In the map displaying program, information of the current position is calculated based on the signals input from the sensors 11 to 14. Further, a mark indicating the current position of the vehicle based on the calculated current position information, a map data read from the map data input device 15 and additional data such as the guide route produced by the route searching program are overlaid on the display screen.

In the above structure, a plurality of display screens (screen sections) is displayed on the display screen at the same time by the control unit 21. For example, as shown in FIG. 3, a map screen (section S1) and a list screen (section S2) are simultaneously displayed on the display screen.

Further, switch indicators A1, A2 are displayed in the map screen S1, and switch indicators B1, B2 are displayed in the list screen S2. The switch indicators A1, A2, B1, B2 are selectable by manipulation of the direction keys 20a of the remote controller 20. Color of a selected switch indicator that is selected by the direction key 20a is changed from a normal color to a predetermined selected color. FIG. 3 shows a condition in which the switch indicator A1 is displayed as selected, for example.

In the external memory 17, correspondences between the manipulation signal and a display content to be displayed next are stored as key information. The correspondences are related to the respective switch indicators. That is, operation of each switch indicator, when the keys 20a through 20c are operated, is specified as key information.

For example, regarding the switch indicator A1, following correspondences are stored as the key information

(1) Select the switch indicator B1 of the list screen S2 when a manipulation signal indicating the right key is input;

(2) Display the list screen S2 on an entire display screen when a manipulation signal indicating the up key is input;

(3) Perform normal shifting operation when a manipulation signal indicating other keys (left key or down key) is input.

Although not illustrated, in the above information (1), an instruction to delete the switch indicators from the map screen S1 is also stored as key information. In the above information (2), an instruction to delete the map screen S1 is also stored as key information, since the list screen s2 is entirely displayed on the display screen. The normal shifting operation of the above information (3) corresponds to operation selecting a switch indicator that is located closest in a direction indicated by the manipulation of the direction key 20a, similar to a well known control.

Regarding the switch indicator A2, correspondences are not defined, for example. It is not always necessary to relate the key information to all switch indicators. The key information can be omitted for some switch indicators. For the undefined switch indicator, the normal shifting operation is performed.

The CPU of the control unit 21 determines a next display content, which is to be displayed next, corresponding to the manipulation signal obtained from the remote controller 20, based on the correspondence stored in the external memory 17 as the key information. Then, the CPU controls to display the determined display content on the display screen.

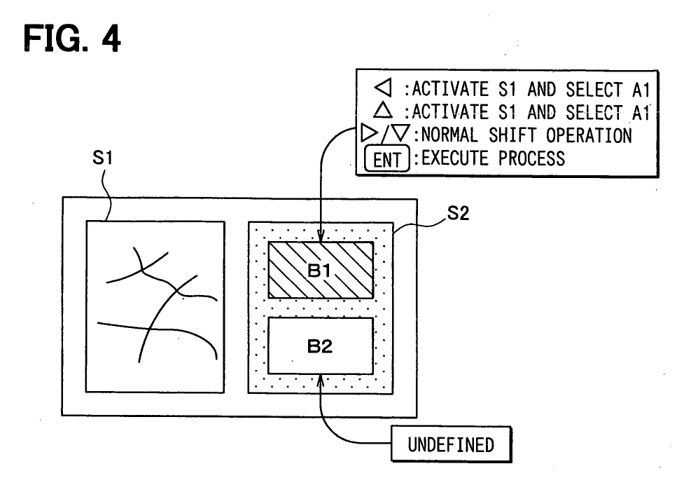

For example, when the manipulation signal of the right key 20a is input from the remote controller 20 in a condition that the switch indicator A1 is selected as shown in FIG. 3, the CPU obtains the key information “Select the switch signal B1 of the list screen S2 next, when the manipulation signal of the right key is input” from the external memory 17. Thus, as shown in FIG. 4, a screen in which the switch indicator B1 is selected is displayed.

Further, the CPU of the control unit 21 controls to delete the switch indicators A1, A2 of the map screen S1 based on the information “Delete the switch indicators of the map screen” stored in the external memory 17. Accordingly, switching of the operation mode from a map screen operation mode to a list screen operation mode is shown in this way. Therefore, it is easy for the user to understand the switching of the operation mode.

In the external memory 17 of the first embodiment, with respect to the switch indicator B1, correspondences between the manipulation signal in accordance with manipulation of the direction keys 20a and the display content to be displayed next on the display screen are stored as key information.

For example, following correspondences are stored in the external memory 17 as the key information for the switch indicator B1.

(1) Activate the screen section S1 next and select the switch indicator A1, when the manipulation signal indicating the left key is input.

(2) Activate the screen section S1 next and select the switch indicator A1, when a manipulation signal indicating the up key is input.

(3) Perform the normal shifting operation when a manipulation signal indicating other keys (right key or down key) is input.

(4) Execute the process determined as for the switch indicator B1, when the manipulation signal indicating the enter key is input.

Regarding the switch indicator B2, correspondences are not defined, similar to the switch indicator A2.

The CPU of the control unit 21 determines the next display content, which corresponds to the manipulation signal obtained from the remote controller 20, based on the correspondences stored in the external memory 17, and controls to display the determined display content.

For example, when the manipulation signal indicating the left key is input from the remote controller 20 in a condition that the switch indicator B1 is selected, as shown in FIG. 4, the CPU obtains the key information “Activate the screen section S1 next and select the switch indicator A1 when the manipulation signal indicating the left key is input” from the external memory 17. Then, a screen shown in FIG. 3 in which the map screen (section S1) is activated and the switch indicator A1 is selected is displayed.

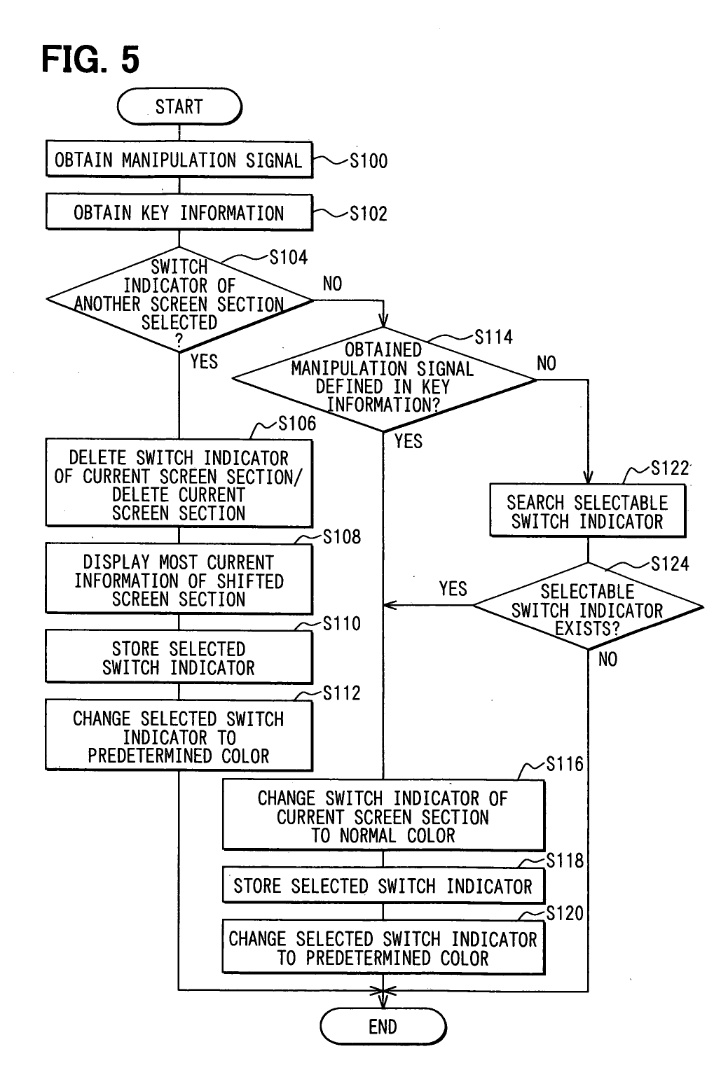

Next, an image display process executed by the CPU of the control unit 21 will be described with reference to FIG. 5. Here, the description is made as the process in which both the map screen S1 and the list screen S2 are displayed on the display screen of the display unit 18 and the switch indicators are displayed on the respective screens, as shown in FIGS. 3 and 4. The CPU regularly executes the following processing after selecting a predetermined switch indicator of the plural switch indicators by a predetermined initialization.

First, at step S100, the manipulation signal of the manipulation switch is obtained from the remote controller 20 through the remote controller sensor 19. Then, at step S102, the key information relating to the selected switch indicator is obtained from the external memory 17.

At step S104, it is determined whether the next display content is a content selecting the switch indicator of another screen section, based on the manipulation signal obtained at step S100 and the key information obtained at step S102. When it is determined that the next display content is the content selecting the switch indicator of the another screen section (“YES” at step S104), the switch indicators of the current screen section are deleted, or the current screen section is deleted based on the key information obtained from the external memory 17, at step S106.

Next, at step S108, most current information of the shifted or selected screen section is displayed on the display screen of the display unit 18. Specifically, the screen in which the switch indicator of another screen section is selected is displayed.

At step S110, the selected switch indicator is stored in the RAM. Further, at step S112, the color of the selected switch indicator is changed to the predetermined selected color. Then, the processing is terminated.

When it is determined that the next display content is not a content selecting the switch indicator of another screen section (“NO” at step S104), it is determined whether the obtained manipulation signal is defined in the stored key information, at step S114. When it is determined that the obtained manipulation signal is defined in the key information (“YES at step S114), the color of the switch indicators on the current screen section is changed to the normal color, at step S116. At step S118, the selected switch indicator is stored in the RAM. At step S120, the color of the selected switch indicator is changed to the predetermined selected color. Then, the processing is terminated.

When it is determined that the obtained manipulation signal is not defined in the key information (“NO” at step S114), switch indicators selectable based on the manipulation signal are searched, at step S122. Specifically, based on the position of the switch indicators displayed on the screen section and the direction included in the manipulation signal obtained at step S100, selectable switch indicators located in the direction indicated in the manipulation signal are searched.

Next, at step S124, it is determined whether the selectable switch indicators exist based on the searched result of step S114. When it is determined that the selectable switch indicators exist (“YES” at step S124), the processing proceeds to steps S116 through S120. On the other hand, when it is determined that no selectable switch indicators exist (“NO” at step S124), the processing is terminated.

As described in the above, the correspondences between the manipulation signal and the next display content are stored in the external memory 17 for the respective switch indicators. The control unit 21 obtains the manipulation signal, determines the next display content based on the obtained manipulation signal and the correspondence stored in the external memory 17, and displays the determined display content. Therefore, it is less likely that the switch indicator of another screen section is erroneously selected based on the relative position of the plural switch indicators while operating on one screen section. Accordingly, the operability of the manipulation switches improves.

### Second Embodiment

In the second embodiment, hardware of the image display apparatus is the same as that of the first embodiment, but processing executed by the control unit 21 is different from that of the first embodiment. Hereafter, different processes are mainly described and like processes are not repeated.

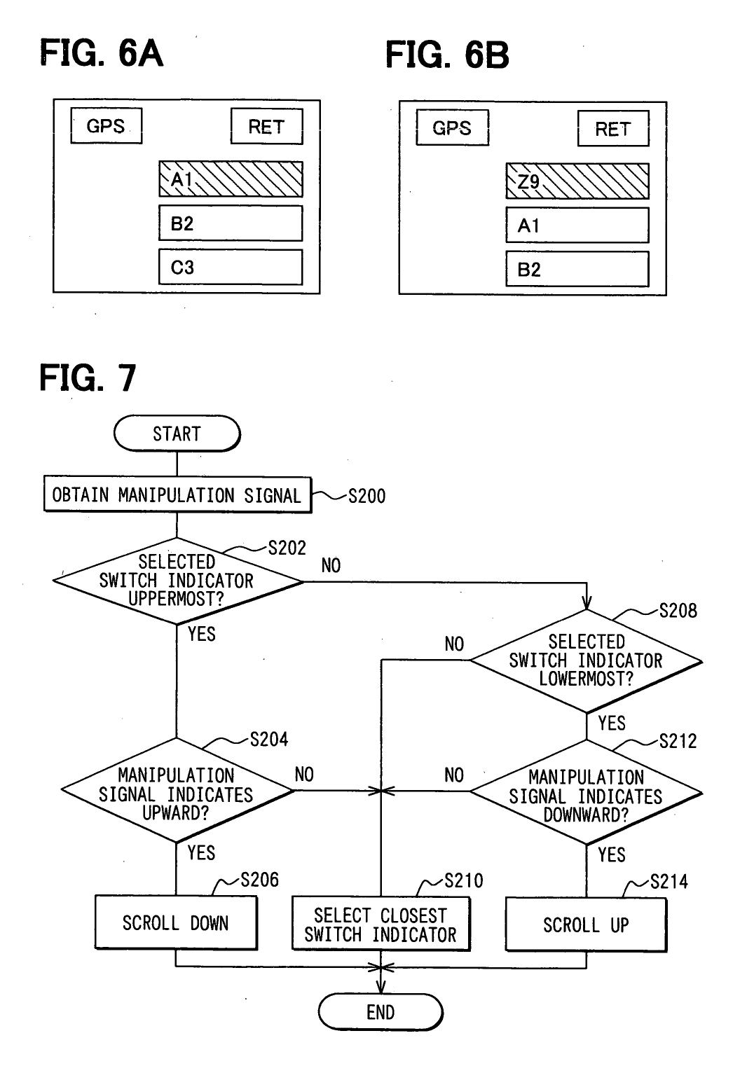

FIGS. 6A and 6B show examples of display images displayed on the display screen. In FIG. 6A, switch indicators A1, B2, C3 are displayed in the from of list. When the listed switch indicators A1, B2, C3 shown in FIG. 6A are scrolled down one row, switch indicators Z9, A1, B2 are displayed, as shown in FIG. 6B.

In the image display apparatus 1 of the second embodiment, correspondences between the manipulation signal and an instruction to scroll the listed switch indicators are stored in the external memory 17, for the respective switch indicators. Specifically, correspondences between the manipulation signal according to manipulation of the direction keys 20a and the next display content, which is to be displayed next, are stored in the external memory 17 as key information, with respect to the switch indicator A1.

For example, regarding the switch indicator A1, following correspondences are stored as key information.

(1) Scroll the listed switch indicators downward, when the switch indicator A1 is located at an uppermost row of the list and a manipulation signal indicating the up key is input.

(2) Scroll the listed switch indicators upward, when the switch indicator A1 is located at the lowermost row of the list display and a manipulation signal indicating the down key is input.

Further, with respect to other switch indicators B2, C3, Z9, A1, B2, similar correspondences are stored as key information in the external memory 17, respectively.

The control unit 21 controls to scroll the listed switch indicators based on the manipulation signal and the correspondence stored in the external memory 17. Therefore, the listed switch indicators can be scrolled without displaying marks such as scroll bar, for scrolling the listed items, on the display screen of the display unit 18.

Next, a display control process executed by the CPU of the control unit 21 of the second embodiment will be described with reference to FIG. 7. The CPU of the control unit 21 selects a predetermined switch indicator of the switch indicators by initialization and regularly executes the following processing.

First, at step S200, the manipulation signal is obtained from the remote controller 20 through the remote controller sensor 19. Next, at step S202, it is determined whether the selected switch indicator is located at the uppermost row of the list. When it is determined that the selected switch indicator is located at the uppermost row, it is determined whether the manipulation signal obtained at step S200 indicates an upward direction at step S204.

When it is determined that the manipulation signal indicates the upward direction (“YES” at step S204), the listed switch indicators are scrolled down so that a hidden item appears on the display screen at step S206. Namely, the display screen shown in FIG. 6A changes to the display screen shown in FIG. 6B. Then, the processing is terminated.

when it is determined that the selected switch indicator is not located at the uppermost row of the list (“NO at step S202), it is determined whether the selected switch indicator is located at the lowermost row of the list at step S208. When it is determined that the selected switch indicator is not located at the lowermost row of the list (“NO” at step S208), the switch indicator that is located closest in the direction indicated in the manipulation signal obtained at step S200 is selected at step S210. Then, the processing is terminated.

When it is determined that the selected switch indicator is located at the lowermost row of the list at step S208 (“YES” at step S208), it is determined whether the manipulation signal obtained at step S200 indicates a downward direction at step S212. When it is determined that the manipulation signal indicates the downward direction (“YES” at step S212), the listed switch indicators are scrolled up so that a hidden item appears on the display screen at step S214. Then, the processing is terminated. When it is determined that the manipulation signal does not indicate the downward direction (“NO” at step S212), the processing proceeds to step S210.

As described in the above, the correspondences between the manipulation signal and the next display content are stored in the external memory 17 for the respective switch indicators. The control unit 21 obtains the manipulation signal in accordance with the manipulation of the manipulation switch. Further, the control unit 21 determines the next display content based on the obtained manipulation signal and the stored correspondence, and controls to display the determined display content. Therefore, hidden items, which cannot be displayed on one screen, can be displayed by scrolling the list without providing the scroll switches such as up switch and down switch. Accordingly, operability of the manipulation switches improves.

In the second embodiment, the list is scrolled based on the obtained manipulation signal and the stored correspondence. However, it is not always necessary to scroll the list display. That is, if the number of switch indicators to be listed is small, it is not necessary to scroll the list display. So, the correspondences stored in the external memory 17 can be changed.

For example, regarding the switch indicator A1, the correspondence stored in the external memory 17 can be changed in a following manner. In a condition shown in FIG. 6A, “Do not scroll the list display when the switch indicator A1 is listed at the uppermost row and the manipulation signal indicating the up key is input”.

In the second embodiment, the plural switch indicators are listed vertically, and the CPU controls to scroll the list display vertically. However, the second embodiment can be applied to a case in which the switch indicators are listed sideways or horizontally. In such a case, the CPU of the control unit 21 controls as follows. When a rightmost switch indicator is selected and a manipulation signal indicating a rightward direction is input, the list screen is scrolled leftward. On the contrary, when a leftmost switch indicator is selected and a manipulation signal indicating a leftward direction is input, the list screen is scrolled rightward.

### Third Embodiment

In the third embodiment, hardware of the image display apparatus 1 is similar to that of the first embodiment, but processing executed by the control unit 21 is different from that of the first embodiment. Hereafter, different processes are mainly described and like processes are not repeated.

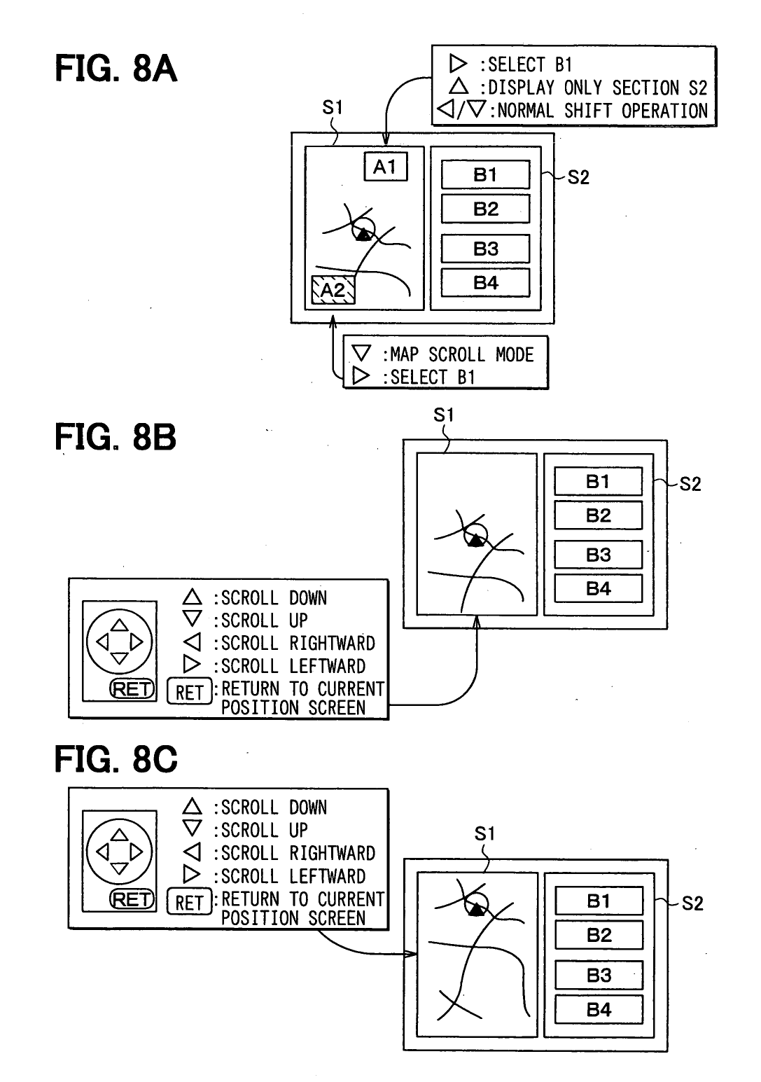

In the image display apparatus 1 of the third embodiment, the map screen (section S1) and the list screen (section S2) are displayed side by side on the display screen of the display unit 18, as shown in FIGS. 8A to 8C. Further, regarding the map screen S1, a mode is selected between a current position display mode in which the current position is indicated in a map and a map scroll mode in which the map is scrolled in accordance with the manipulation signal.

In FIG. 8A, a current position display screen is displayed on the left side of the display screen and a list screen is displayed on the right side. In FIG. 8B, a map scroll screen is displayed on the left side and the list screen is displayed on the right side. The section S1 of FIG. 8C shows the map screen that is scrolled upward from the map screen shown in FIG. 8B. Further, the switch indicators A1, A2 are displayed on the current position display screen. In the map scroll screen, however, the switch indicators A1, A2 are not displayed.

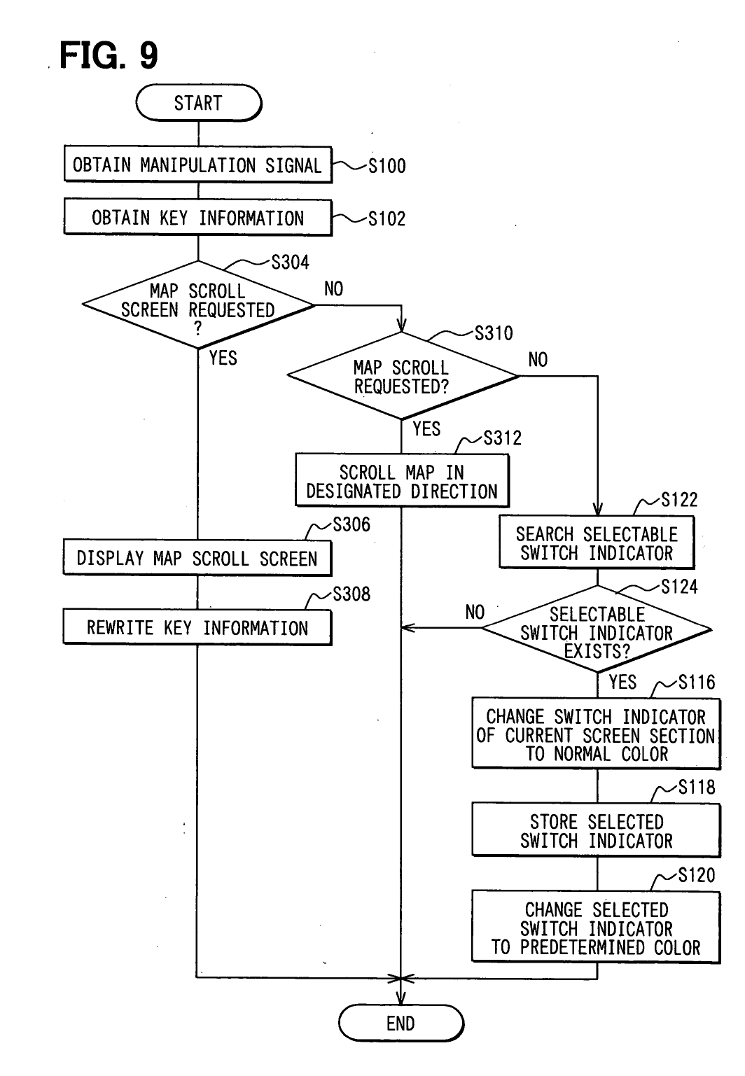

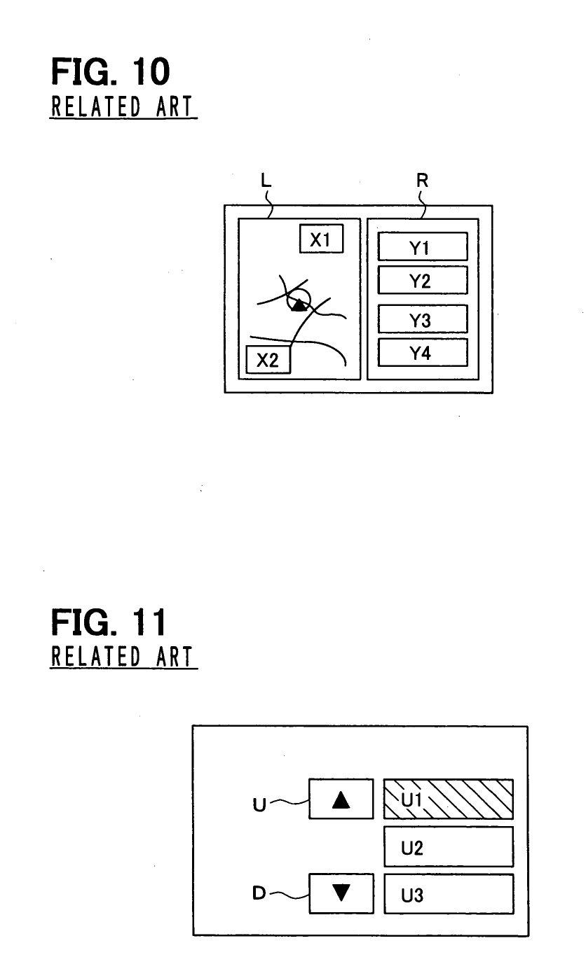

The display control process executed by the CPU of the control unit 21 of the third embodiment is shown in a flow chart of FIG. 9. Here, the map screen S1 and the list screen S2 are switched in a manner similar to the first embodiment. Also, the list screen S2 is displayed or scrolled in a manner similar to the above embodiments. Hereafter, the processing for switching the mode between the current position display mode and the map scroll mode will be mainly described with reference to FIGS. 8 and 9.

As shown in FIG. 8A, in the current position display mode, one of the switch indicators A1, A2 is selectable in accordance with the manipulation of the direction key 20a. In the map scroll mode, the map screen is scrolled in accordance with the manipulation of the direction key 20a. The operations according to the manipulation of the direction keys 20a are different in each mode. In the external memory 17 of the third embodiment, therefore, both key information for the current position display mode and key information for the map scroll mode are stored.

As the key information for the current position display mode, following correspondences (1) through (3) are stored regarding the switch indicator A1.

(1) Select the switch indicator B1 on the list screen S2 when the manipulation signal indicating the right key is input.

(2) Display the list screen S2 on the entire display screen when the manipulation signal indicating the up key is input.

(3) Perform the normal shifting operation when the manipulation signal indicating the other keys (left key or down key) is input.

Regarding the switch indicator A2, following correspondences (1) and (2) are stored.

(1) Display the map scroll screen when the manipulation signal indicating the down key is input.

(2) Select the switch indicator B1 on the list screen S2 when the manipulation signal indicating the right key is input.

As the key information for the map scroll mode, following correspondences (1) through (5) are stored.

(1) Scroll the map downward, when the manipulation signal indicating the up key is input.

(2) Scroll the map upward, when the manipulation signal indicating the down key is input.

(3) Scroll the map rightward, when the manipulation signal indicating the left key is input.

(4) Scroll the map leftward, when the manipulation signal indicating the right key is input.

(5) Return to the current position display screen, when the manipulation signal indicating the return key is input.

The CPU of the control unit 21 regularly executes the following processing after selecting a predetermined switch indicator by initialization.

Referring to FIG. 9, at step S100, the manipulation signal from the remote controller 20 is obtained through the remote controller sensor 19. Then, at step S102, key information relating to the selected switch indicator is obtained from the external memory 17. Steps S100 and S102 are the same as steps S100 and S102 of the first embodiment.

Next, at step S304, it is determined whether an instruction to display the map scroll screen exists based on the manipulation signal obtained at step S100 and the key information obtained at step S102. When it is determined that the instruction to display the map scroll screen exists (“YES” at step S304), the map scroll screen is displayed at step S306.

Next, the key information to be obtained at step S102 is rewrote to the key information for the map scroll mode at step S308. Specifically, the key information obtained at step S102 by the CPU of the control unit 21 is stored in a predetermined area of the external memory 17. The key information stored in the predetermined area is rewrote to the key information as for the map scroll mode. Then, the processing is terminated.

When it is determined to display a screen other than the map scroll screen (“NO” at step S304), it is determined whether an instruction to scroll the map exists, based on the manipulation signal obtained at step S100 and the key information obtained at step S102. When it is determined that the instruction to scroll the map exists (“YES” at step S310), the map is scrolled in a designated direction at step S312. Then, the processing is terminated.

On the other hand, when it is determined that the map scroll instruction does not exist (“NO” at step S310), the processing is terminated after executing steps S122 through S120. Steps S122 through S120 are similar to those of the first embodiment shown in FIG. 5.

Further, a correspondence “Display the current position screen when a manipulation signal indicating the return key is input” is stored as key information in the external memory 17. Although not illustrated, the CPU determines whether an instruction to display the current position display screen exists based on the manipulation signal obtained at step S100 and the key information obtained at step S102. Further, when it is determined that the instruction to display the current position display screen exists, the current position display screen is displayed, and the key information of step S102 is rewrote to the key information of the current position mode.

As mentioned above, the control unit 21 provides the current position display mode in which a plurality of switch indicators selectable in accordance with the manipulation signals are displayed and the map scroll mode for scrolling the map in accordance with the manipulation signals. Here, the current position display mode corresponds to the switch indicator display mode. The external memory 17 stores both the key information for the current position display mode and the key information for the map scroll mode.

When the plurality of switch indicators are displayed on the display screen in the current position display mode, the control unit 21 obtains the key information for the current position display mode from the external memory 17. On the other hand, when the map is displayed on the display screen in the map scroll mode, the control unit 21 obtains the key information for the map scroll mode from the external memory 17. Therefore, in the current position display mode, the switch indicators are selectable in accordance with the manipulation signals, for example. On the other hand, in the map scroll mode, the map can be scrolled in accordance with the manipulation signals.

Here, the process in which the control unit 21 obtains the manipulation signal through the remote controller sensor 19 in accordance with the manipulation of the remote controller 20 19 provides a manipulation signal obtaining means. The process in which the control unit 21 controls to display various information on the display screen of the display unit 18 provides a display control means. The external memory 17 provides a storing means. The process at step S202 of FIG. 7 provides an uppermost row determining means. The process at step S204 of FIG. 7 provides an upward operation determining means. The process at step S208 of FIG. 7 provides a lowermost row determining means. The process at step S212 of FIG. 7 provides a downward operation determining means.

The present invention should not be limited to the disclosed embodiment, but may be implemented in other ways without departing from the spirit of the invention.

For example, in the above embodiments, the control unit 21 obtains the manipulation signals from the remote controller 20 through the remote controller sensor 19. Instead of the remote controller 20, a direction switch can be provided on the periphery of a steering wheel. The direction switch is connected to the control unit 21 through an interior LAN. So, the control unit 21 obtains the manipulation signals from the direction switch.

In the above embodiments, the key information is stored in the external memory 17. However, the storing means is not limited to the external memory 17. The key information can be stored in other storage media.

The processes of steps of the flow charts of FIGS. 5, 7 and 9 are understood as means for achieving respective functions. The control unit 21 is not limited to software. Instead, the control unit 21 can be provided by a hardware.

What is claimed is:

1. An image display system comprising:
a manipulation signal obtaining unit for obtaining a manipulation signal in accordance with manipulation of a manipulation switch;
a display control unit for displaying a plurality of switch indicators, which are selectable based on the manipulation signal, on a display screen; and
a storing unit for storing correspondences between the manipulation signal and a display content to be displayed next on the display screen, for the respective switch indicators, wherein
the display control unit determines the display content to be displayed next based on the manipulation signal obtained by the manipulation signal obtaining unit and the correspondence stored in the storing unit and displays the determined display content on the display screen.

2. The image display system according to claim 1, wherein
the display control unit displays a plurality of screen sections on the display screen,
the display content includes a screen section to be activated next,
the storing unit stores correspondences between the manipulation signal and the screen section to be activated next, for the respective switch indicators, and
the display control unit displays a predetermined screen section of the screen sections as activated, based on the obtained manipulation signal and the stored correspondence.

3. The image display system according to claim 1, wherein
the display content includes a switch indicator to be selected next,
the storing unit stores correspondences between the manipulation signal and the switch indicator to be selected next, for the respective switch indicators, and
the display control unit displays a predetermined switch indicator of the switch indicators as selected, based on the obtained manipulation signal and the stored correspondence.

4. The image display system according to claim 1, wherein
the display control unit displays the switch indicators in a form of list on the display screen,
the display content includes an instruction to scroll the listed switch indicators,
the storing unit stores correspondences between the manipulation signal and the instruction to scroll the listed switch indicators, for the respective switch indicators, and
the display control unit scrolls the listed switch indicators based on the obtained manipulation signal and the stored correspondence.

5. The image display system according to claim 4, further comprising:
an uppermost row determining unit for determining whether a switch indicator selected based on the manipulation signal is located at an uppermost row of the list; and
an upward operation determining unit for determining whether the obtained manipulation signal indicates an upward operation, wherein
the display control unit scrolls the list downward based on the stored correspondence, when it is determined that the selected switch indicator is located at the uppermost row of the list and the obtained manipulation signal indicates the upward operation.

6. The image display system according to claim 4, further comprising:
a lowermost row determining unit for determining whether a switch indicator selected based on the manipulation signal is located at a lowermost row of the list; and
a downward operation determining unit for determining whether the obtained manipulation signal indicates a downward operation, wherein
the display control unit scrolls the list upward based on the stored correspondence, when it is determined that the selected switch indicator is located at the lowermost row of the list and the obtained manipulation signal indicates the downward operation.

7. The image display system according to claim 1, wherein
the display control unit provides a first mode in which the selectable switch indicators are displayed on the display screen and a second mode in which a map screen is scrolled on the display screen,
the storing unit stores first key information for the first mode and second key information for the second mode, and
the display control unit obtains the first key information in the first mode and the second key information in the second mode.

8. The image display system according to claim 2, wherein
the display content includes a switch indicator to be selected next,
the storing unit stores correspondences between the manipulation signal and the switch indicator to be selected next, for the respective switch indicators, and
the display control unit displays a predetermined switch indicator of the switch indicators as selected based on the obtained manipulation signal and the stored correspondence.

9. The image display system according to claim 2, wherein
the display control unit provides a first mode in which the selectable switch indicators are displayed on the display screen and a second mode in which a map screen is scrolled on the display screen,
the storing unit stores first key information for the first mode and second key information for the second mode, and
the display control unit obtains the first key information in the first mode and the second key information in the second mode.
